(19) United States
(12) Patent Application Publication
(10) Pub. No.: US 2010/0300820 A1
(43) Pub. Date: Dec. 2, 2010

(54) Torsional Vibration Damping System for the Drive Train of a Vehicle

(75) Inventors: Cora Carlson, Dittelbrunn (DE); Andreas Orlamünder, Schonungen (DE); Thomas Busold, Fulda (DE); Thomas Dögel, Bad Kissingen (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshagen AG, Friedreichshafen (DE)

(21) Appl. No.: 12/599,452

(22) PCT Filed: Apr. 22, 2008
(86) PCT No.: PCT/EP2008/003217

§ 371 Date: Dec. 8, 2009

(30) Foreign Application Priority Data
May 8, 2007 (DE) 10 2007 021 436.9

(51) Int. Cl. F16F 15/16

(52) U.S. Cl. 188/290

(57) ABSTRACT

A torsional vibration damper system includes a primary side and a secondary side coupled to the primary side by a damper fluid arrangement for rotation and for relative rotation with respect to one another. The damper fluid arrangement has a first damper fluid which transmits a torque between the primary side and the secondary side and a second damper fluid which is loaded when there is an increase in pressure in the first damper fluid. A rotary feedthrough supplies or removes first damper fluid to or from at least one displacement chamber of the damper fluid arrangement and a pressure fluid generation system for providing first damper fluid to be supplied to the damper fluid arrangement via the rotary feedthrough. The pressure fluid generation system comprises at least two pressure fluid pumps.

### PRIORITY CLAIM

This is a U.S. national stage of application No. PCT/EP2008/003217, filed on Apr. 22, 2008 which claims Priority to the German Application No.: 10 2007 021 436.9, filed: May 8, 2007; the contents of both being incorporated herein by reference.

### BACKGROUND OF THE INVENTION

1. Field of the Invention

The present invention is directed to a torsional vibration damper system for a drivetrain of a vehicle comprising a primary side and a secondary side which is coupled to the primary side by a damper fluid arrangement for rotation around an axis of rotation and for relative rotation with respect to one another. The damper fluid arrangement comprises a first damper fluid having lower compressibility that transmits a torque between the primary side and the secondary side and a second damper fluid having higher compressibility which is loaded when there is an increase in pressure in the first damper fluid. A rotary feedthrough is provided for supplying or removing first damper fluid to or from at least one displacement chamber of the damper fluid arrangement. The displacement chamber contains first damper fluid, the volume of the at least one displacement chamber is alterable by the relative rotation of the primary side with respect to the secondary side so that the loading of the second damper fluid by the first damper fluid can be altered, further comprising a pressure fluid generation system for providing first damper fluid to be supplied to the damper fluid arrangement via the rotary feedthrough.

2. Prior Art

A torsional vibration damper system of the type mentioned above is shown in a generalized manner in FIG. 1. FIG. 1 shows the torsional vibration damper system 12 integrated in a drivetrain 10 and acting substantially between a drive unit 14, i.e., an internal combustion engine, and a clutch 16 and transmission 18. The torsional vibration damper system 12 which is constructed substantially in the manner of a dual-mass flywheel comprises a primary side 20 to be coupled with a driveshaft of the unit 14 and a secondary side 22, which conveys torque in a direction of the clutch 16. The primary side 20 and the secondary side 22 define displacement chambers 24, indicated schematically, in which substantially incompressible first damper fluid such asoil or the like is arranged. When relative rotations between the primary side 20 and the secondary side 22 are triggered by torque fluctuations or by a torque to be transmitted, this first damper fluid is displaced from the displacement chambers 24 and loads a second damper fluid which is contained in chambers 26 provided for this purpose and which has a higher compressibility, e.g., a gas. Loading of the more highly compressible second damper fluid produces a compression effect which generates a restoring force to move the primary side 20 and secondary side 22 back in direction of a neutral relative rotational position with respect to one another. By varying the pressure of the first damper fluid, it is possible to adjust the operative characteristics of the damper fluid arrangement 28 which substantially comprises the first damper fluid and second damper fluid. To this end, there is provided a rotary feedthrough, designated generally by 30, through which the first damper fluid can be introduced into the displacement chambers 24 under pressure and also removed from it.

A pressure fluid generation system arranged outside of the rotating system area is designated generally by 32 in FIG. 1. This pressure fluid generation system 32 comprises a pressure fluid pump 36 which is driven, for example, by an electric motor 34 and which receives fluid from a reservoir 38 via a suction line 40 and a fluid filter 42 and releases the fluid via a pressure line 44 with a check valve 46 and another fluid filter 48. Further, a pressure accumulator 50 is provided in this pressure line 44 downstream of the check valve 46 in the flow direction of the pressure fluid. Accordingly, when the pressure fluid pump 36 is disabled, first damper fluid can be supplied under pressure to the primary side 20 and secondary side 22, respectively, from the pressure accumulator 50. Two switching valves 52, 54 which can operate either discretely, i.e., can be switched on and off, or continuously, that is, can operate either proportionally, progressively, degressively, or so as to be dependent upon characteristic curves, ensure that the damper fluid line 44 or the pressure accumulator 50 can be selectively connected to the displacement chambers 24 by additional fluid lines 56, 58 to increase the pressure of the first damper fluid therein or that the displacement chambers 24 and, therefore, the fluid lines 56, 58 can be selectively connected to fluid lines 60, 62 leading back to the fluid reservoir 38. It should be noted in this respect that the two fluid lines 56, 58 communicate via the rotary feedthrough 30 with different groups of displacement chambers 24, a first group of which is operative in the pull state, i.e., compressively loaded when torque is being transmitted from the drive unit 14 to the clutch 16, while the other group is compressively loaded when the system is in the push state, i.e., in the engine braking state, in which a torque is to be transmitted from the clutch 16 in direction of the drive unit 14. As is shown in FIG. 1, when one group of these displacement chambers 26 communicates with the pressure line 44 via the associated valve (in this case, valve 52), the other group of displacement chambers 26 or the associated valve (in this case valve 54) communicates with one of the lines 60 or 62 and, therefore, with the fluid reservoir 38. Leaked oil from the rotary feedthrough 30 can be conveyed back to the fluid reservoir 38 by a drainage line 31.

A pressure sensor 64 acquires the pressure in the pressure line 44 or pressure line segments 66, 68 leading to the valves 52, 54 and supplies a corresponding pressure signal to a control device 70. This control device 70 receives signals from the speed sensors 72, 74. Speed sensor 72 acquires the speed of the primary side 20, while speed sensor 74 acquires the speed of the secondary side 22. Based on these signals and, if necessary, other signals or information, the control device 70 controls the engine 34 in order to increase the pressure in the pressure fluid line 44, if required, and the control device 70 controls the valves 52, 54 in order to connect the two groups of displacement chambers 24 to the pressure fluid line 44 or fluid reservoir 38, depending on the relative rotational state or relative rotational speed of the primary side 20 with respect to the secondary side 22.

The torsional vibration damper system whose basic construction has been described above with reference to FIG. 1 has the fundamental drawback that a compromise must be made between optimizing the delivery volume or the maximum achievable pressure owing to the fact that only one pressure fluid pump is provided. On the other hand, this pressure fluid pump with the associated drive unit represents an additional group of components which, of course, occupies additional installation space and adds to weight and cost.

### SUMMARY OF THE INVENTION

It is an object of the present invention to provide a torsional vibration damper system which more efficiently delivers the first damper fluid required for achieving vibration damping functionality and which also makes better use of the installation space.

This object is met by a torsional vibration damper system for the drivetrain of a vehicle comprising a primary side and a secondary side which is coupled to the primary side by a damper fluid arrangement for rotation around an axis of rotation and for relative rotation with respect to one another, wherein the damper fluid arrangement comprises a first damper fluid having lower compressibility which transmits torque between the primary side and the secondary side and a second damper fluid having higher compressibility which is loaded when there is an increase in pressure in the first damper fluid, further comprising a rotary feedthrough for supplying or removing first damper fluid to or from at least one displacement chamber of the damper fluid arrangement, which displacement chamber contains first damper fluid, the volume of the at least one displacement chamber being alterable by the relative rotation of the primary side with respect to the secondary side so that the loading of the second damper fluid by the first damper fluid can be altered, and a pressure fluid generation system for providing first damper fluid to be supplied to the damper fluid arrangement via the rotary feedthrough.

According to a first aspect of the invention, the pressure fluid generation system comprises at least two pressure fluid pumps.

By providing at least two pressure fluid pumps, it is possible to design these two pressure fluid pumps such that they are optimized for the existing requirements. For example, one of the pressure fluid pumps can be designed to generate a greater volume flow and another pressure fluid pump can be designed to generate a greater fluid pressure. Accordingly, it is possible to put one of these pressure fluid pumps into operation depending on whether a large volume flow or a large maximum pressure is required depending on the operating state.

Each of these pressure fluid pumps is preferably assigned its own drive. Alternatively, particularly to save on cost, weight and installation space, a plurality of pressure fluid pumps can be driven in common by one pressure fluid pump drive.

At least one of the pressure fluid pump drives comprises an electric motor. Further, a pressure accumulator may be associated with each pressure fluid pump.

According to a second aspect of the present invention, the pressure fluid generation system comprises a pressure fluid pump and a pressure fluid pump drive associated therewith, and the pressure fluid pump drive comprises a vehicle drive unit.

Accordingly, in this embodiment, the torsional vibration damper system makes use of the drive unit that is generally provided in a drivetrain to generate the torque and driving force for a pressure fluid pump. This is particularly advantageous insofar as no additional drive need be provided for the pressure fluid pump. Further, drive units of the kind mentioned above are generally high-torque drive units so that this also allows great freedom in designing the pressure fluid pump with respect to the achievable delivery characteristics.

The pressure fluid pump can be coupled with a drive member of the vehicle drive unit in a fixed speed conversion ratio. In addition, it is possible that the pressure fluid pump is coupled with a drive member of the vehicle drive unit by means of a shiftable clutch arrangement. In this way, the pressure fluid pump can be uncoupled when the supply of pressure fluid is not required, and the loading of the drive unit caused by this is accordingly eliminated.

According to another aspect of the invention, the pressure fluid generation system comprises a transmission oil pump arranged in a transmission arrangement.

Transmission oil pumps of the type mentioned above are provided particularly in automatic transmissions, at least partly also to supply operating oil to a hydrodynamic torque converter which is generally provided in such transmissions. This transmission oil pump can also be used to provide the required fluid pressure for the first damper fluid, in which case, of course, the transmission oil, i.e., the medium conveyed through the transmission oil, can also provide the first damper fluid, i.e., the transmission oil pump can form one of the pressure fluid pumps.

Further, in a system of this kind, the pressure fluid generation system can also comprise a pressure fluid pump which is driven by a pump drive motor.

To avoid a disadvantageous interaction between the transmission oil pump and the additional pressure fluid pump, the pressure fluid pump can be uncoupled from the pressure fluid circuit of the transmission pump by a valve arrangement.

A pressure accumulator can be associated with the pressure fluid pump.

According to another aspect of the present invention, the pressure fluid generation system comprises a pressure fluid pump and a pressure fluid pump drive which is associated with the latter, and the pressure fluid pump drive uses a third fluid as a driving medium.

Accordingly, in this embodiment an electric-motor drive is not used directly to drive a pressure fluid pump; rather another fluid which is generally present in a vehicle and which is under pressure, or the pressure characteristics of this fluid, is used.

To this end, for example, the third fluid can be introduced intermittently into a drive work chamber to move a pump member of the pressure fluid pump alternately in reciprocating motion in a delivery work chamber of the pressure fluid pump. Accordingly, the movement of a pump member which is generally advantageous for or required for pumping operation is brought about by intermittently introducing this third fluid.

To convey the fluid from a fluid reservoir in a direction of the displacement chambers to be supplied, the delivery work chamber is connected to a fluid reservoir by a suction line with a check valve and delivers the first damper fluid via a pressure line with a check valve.

To this end, a pressure accumulator can be associated with the pressure line having a check valve.

The third fluid can be provided, for example, by the lubricating fluid of a drive unit, the coolant of a drive unit, the hydraulic oil of a power steering arrangement, the coolant of an air conditioning system, the fuel for a drive unit, the brake fluid of a brake system, window washer water, the damping fluid of an engine suspension, or the compressed air of a chassis which is controlled/regulated by compressed air.

According to another aspect of the invention; in the torsional vibration damper system which is outfitted with the basic construction the pressure fluid supply system comprises a pressure fluid pump with a delivery member reciprocating in a delivery work chamber and a drive associated with the delivery member, wherein the drive comprises a drive element which is movable by the driving movement of a vehicle in driving operation and a connection arrangement between the drive element and the delivery member.

Accordingly, for example, an electric motor drive for the pressure fluid pump can be omitted in this construction. The movement of a drive element, e.g., part of a wheel suspension, occurring during driving operation is used.

To further simplify the construction, the pressure fluid pump is part of a shock absorber of a wheel suspension or part of a steering damper of a vehicle steering system. Accordingly, the fluid pressure generated during damping operation in a damper, i.e., a shock absorber or a steering damper, can be used to generate the pressure for the first damper fluid which is to be fed into the displacement chambers.

According to another aspect of the present invention, the pressure fluid generation system comprises a pressure fluid pump with a pressure fluid pump drive for providing pressure fluid used in a vehicle, the pressure fluid also provides the first damper fluid.

Accordingly, in this constructional variant a pressure fluid which is otherwise used for different purposes in a vehicle is also used as the first damper fluid so that an additional pressure fluid pump for the first damper fluid is not required. This can be realized in particular when the pressure fluid is also suitable as the first damper fluid because of its consistency, i.e., when the pressure fluid has an oily consistency.

A vehicle can be provided with a chassis that is controlled/regulated by pressure fluid, this pressure fluid is supplied to the chassis for adjusting the chassis characteristics. The pressure fluid used for adjusting the chassis characteristics is simultaneously also used for providing the first damper fluid which is under pressure, so that there is no need for an additional pressure fluid pump or a corresponding pump drive for generating the first damper fluid, which is under pressure.

To prevent a negative interaction of different pressure fluid circuits, and to ensure that the required chassis characteristics can be adjusted in critical driving situations, a fluid circuit of the chassis which is controlled/regulated by pressure fluid is preferably connected to a pressure fluid circuit of the damper fluid arrangement by a valve arrangement.

This fluid circuit of the damper fluid arrangement can also have a pressure accumulator in this embodiment.

According to another advantageous aspect of the present invention, a heat exchanger arrangement is associated with the first damper fluid for heating the same. This ensures a sufficient flowability of the first damper fluid so that there are substantially no changes in the effective characteristics of the damper fluid arrangement induced by changes in temperature. In this connection, it can be provided, for example, that the heat exchanger arrangement uses a cooling fluid of a drive unit as a heat exchanger medium.

### BRIEF DESCRIPTION OF DRAWINGS

The present invention will be described in the following with reference to the accompanying drawings.

FIG. 1 is a schematic diagram showing basic construction of a torsional vibration damper system for the drivetrain of a vehicle;

FIG. 2 is a view of a torsional vibration damper system constructed according to an embodiment of the invention;

FIG. 3 is an embodiment of another view of a torsional vibration damper system constructed according to the invention;

FIG. 4 is an embodiment of another view of a torsional vibration damper system constructed according to the invention;

FIG. 6 is an embodiment of another view of a torsional vibration damper system constructed according to the invention;

FIG. 7 is an embodiment of another view of a torsional vibration damper system constructed according to the invention; and

FIG. 8 is an embodiment of another view of a torsional vibration damper system constructed according to the invention.

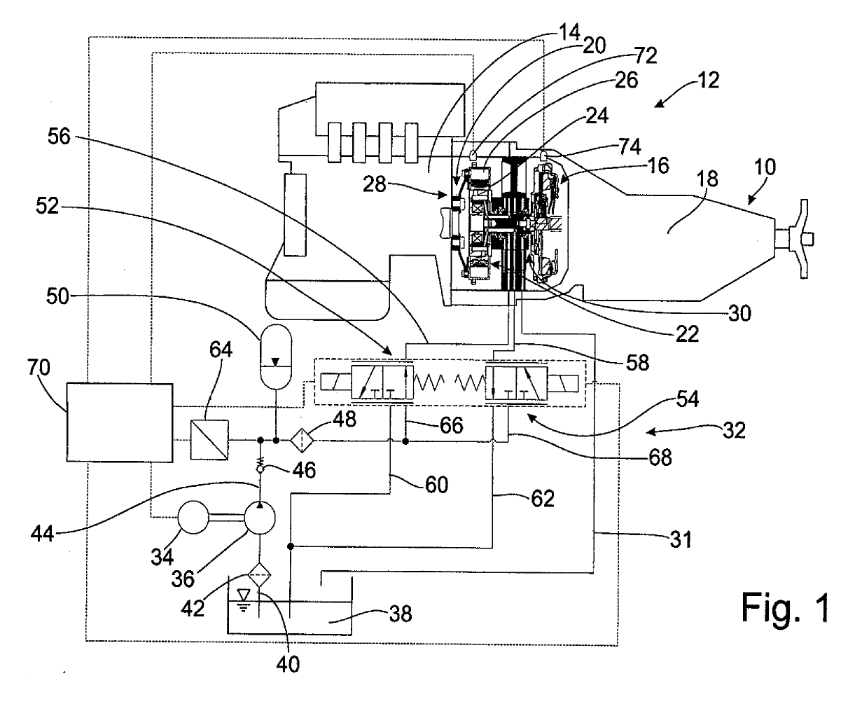

### DETAILED DESCRIPTION OF THE DRAWINGS

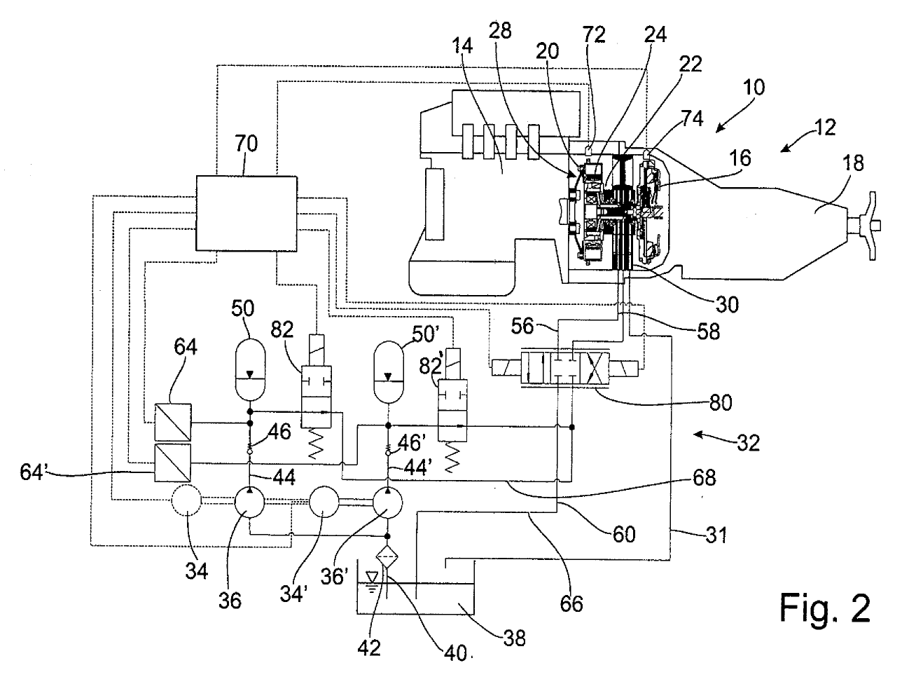

FIG. 2 shows a drivetrain 10 and a torsional vibration damper system 12 for drivetrain 10 in which the pressure fluid generation system 32 comprises two pressure fluid pumps 36 and 36′. An electric motor 34 and 34′, respectively, is associated as a drive with each of these pressure fluid pumps 36, 36′, these two motors being controlled in turn by the control device 70. The two pumps 36, 36′ receive the delivery fluid from the fluid reservoir 38 via the suction line 40 and the fluid filter 42 and deliver it in the course of pump operation via pressure lines 44, 44′ with check valves 46, 46′ provided therein. Check valves 46, 46′ prevent the fluid from being returned through the pumps. Following the respective check valves 46, 46′, a pressure accumulator 50, 50′ is associated with each of the pressure fluid pumps 36, 36′. Further, a cutoff valve 82, 82′, which is likewise controlled by the control device 70. A three-way valve 80 in the flow path selectively interrupts or releases the connection of the respective pressure lines 44, 44′ to the respective pressure line segments 66, 68 leading to the three-way valve 80. Pressure sensors 64, 64′ acquire pressure in the lines.

The two pressure fluid pumps 36, 36′ can be designed differently. For example, pressure fluid pump 36 can be optimized with a view to generating the highest possible fluid pressure, while pressure fluid pump 36′ can be optimized for the largest possible fluid flow. If a comparatively large volume flow of the fluid to be supplied to the different displacement chambers 24 is required during operation, the pump 36′ can then initially be operated to deliver a comparatively large volume flow of this kind or also to charge the pressure accumulator 50′ correspondingly. The cutoff valve 82′ is in its through-position so that the first damper fluid, which is under pressure, can be introduced via the three-way valve 80 into the displacement chambers 24 provided for this operating state, while the other displacement chambers, i.e., the displacement chambers operative in the push state, for example, are released to the reservoir 38 via the fluid line 60. When the pressure fluid pump 36′ has reached its limit with respect to the achievable pressure, it can be deactivated, whereupon the pressure fluid pump 36 is activated in order to charge the pressure accumulator 50 and, insofar as it is necessary, to increase the fluid pressure in the displacement chambers 24 provided for this purpose by cutoff valve 82, which is then switched to the released position, and by means of the three-way valve 80. In this state, the cutoff valve 82′ is in its blocking position so that there is no possibility of a pressure reaction on the pressure accumulator 50′ via the pressure fluid line segments 66, 68. In this way, it is also possible for the two pressure fluid pumps 36, 36′ to use pressure accumulators 50 and 50′ which are also optimally designed for the achievable pressures or volume flows.

The design and optimization of the two pressure fluid pumps 36, 36′ for generating the highest possible fluid pressure or the largest possible volume flow can be carried out, by different structural configurations. For example, centrifugal pumps which generate a comparatively large volume flow at a given work frequency but which can only achieve lower pressures can be used as pump 36′. Piston pumps or gear pumps are optimized with respect to the achievable pressure.

Switching between a pull state and a push state is carried out by corresponding adjustment of the three-way valve 80 so that one of the groups of displacement chambers 24 is connected to the pressure fluid line segments 66, 68, while the other group is connected to the fluid line 60 or, as is also shown in FIG. 2, both groups of displacement chambers 24 are blocked and a variation in pressure can therefore not be generated.

Of course, the two pressure fluid pumps 36, 36′ in the construction shown in FIG. 2 can also be driven jointly by one drive motor which can then cooperate, e.g., by shiftable clutches, alternately with one or the other pressure fluid pump. The design of the pumps 36, 36′ is especially relevant when the two pumps 36, 36′ are driven by a common drive and are therefore also provided in principle for working at the same or similar work frequency ranges. Further, the activation and deactivation of the pressure fluid pumps 36, 36′ can, of course, be carried out while taking into account various operating information such as, e.g., the information supplied by the speed sensors 72, 74 about the relative speed status between the primary side 20 and the secondary side 22,

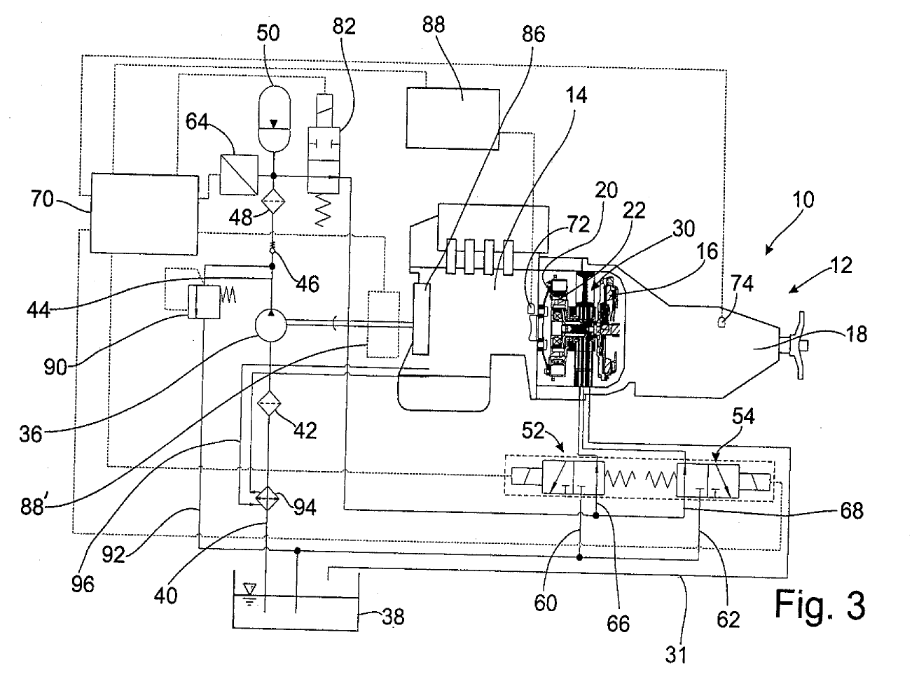

FIG. 3 shows another embodiment of the drivetrain 10 with a torsional vibration damper system 12. In this constructional variant, the pressure fluid pump 36 is not driven by its own dedicated drive motor, i.e., an electric motor, rather, the drive unit 14, for example, an internal combustion engine, supplies the driving torque.

For this purpose, a schematically shown belt drive 86 of the drive unit 14 can be used to operate the pressure fluid pump 36. For example, a belt pulley provided at the crankshaft drives the pressure fluid pump 36, or a belt pulley provided for a generator, water pump, air conditioning compressor, or auxiliary steering pump can be used directly or by coupling to a separate belt pulley. In particular, when a separate belt pulley is used, a multiplication gear ratio or reduction gear ratio which is optimized for the operation of the pressure fluid pump 36 can be selected to operate the pressure fluid pump 36 in the optimal speed range or in the optimal torque range. Further, it is possible to use a transmission 88′, indicated by dashed lines in FIG. 3, in the torque transmission path between the drive unit 14 and the pressure fluid pump 36 in order to achieve optimal speed. In addition or alternatively, a shiftable clutch can be provided in the torque transmission path. This shiftable clutch can, be controlled by the control device 70 to selectively initiate or halt operation of the pressure fluid pump 36. In principle, the torque for the pressure fluid pump 36 can also be tapped at other areas, for example, in the area of a cam chain or vertical shaft drive. It is important that the driving torque is supplied directly by the drive unit 14 and not by a separate drive.

First damper fluid delivered under pressure in the pressure line 44 by the pressure fluid pump 36 flows again via a check valve 46 and a fluid filter 48 in direction of a pressure accumulator 50 and, via the latter, through a cutoff valve 82 in direction of the two valves 52, 54. A motor control device a transmission 88′ which, for example, can receive the input signal of the speed sensor 72 on the input side, i.e., on the primary side, so as also to have information about the engine speed, supplies information about the rotational state of the drive unit 14 and, accordingly, also of the primary side 20, to the control device 70. Accordingly, a speed sensor 72 internal to the engine can be used to supply the control signals for the operation of the torsional vibration damper system 12. On the output side, i.e., on the secondary side, the speed signal of a speed sensor 74 provided in the transmission 18 can be used and, e.g., applied directly to the control device 70. In principle, a tachometer signal can also be used to supply information about the vehicle speed and, taking into account the respective selected gear speed in the transmission 18, about the speed of the secondary side 22.

Further, a pressure limiting valve 90 is provided which ensures that the pressure of the first damper fluid in the pressure line 44 does not exceed a permissible value. When this value is reached, a pressure limiting valve opens and causes a decrease in pressure or expansion via a fluid line by diverting a portion of the delivered fluid in direction of the reservoir 38. Of course, a pressure limiting valve of this type can also be provided in the embodiment forms described above and in the embodiment forms which will be described below.

A substantial advantage of the system shown in FIG. 3 consists in that the pressure fluid pump 36 does not require its own drive motor. This pressure fluid pump 36 can always be operated even when the drive unit 14 is in operation.

To ensure that the first damper fluid has a uniform flowability, i.e., viscosity, substantially independent from external environmental conditions, a heat exchanger 94 can be provided in the flow path of the first damper fluid, preferably in the area of the suction line 40, in order, as the case may be, to heat or cool the first damper fluid or to maintain it within a preferred temperature range. A heat exchanger medium, i.e., the coolant of the drive unit 14, for example, can be supplied to the heat exchanger 94 via a circuit 96 which, for example, can branch off from the cooling circuit of the drive unit 14 or can form a subdivision thereof A vibration damping characteristic of the torsional vibration damper system which is substantially independent from environmental influences can be ensured by providing the first damper fluid with a given or approximately constant temperature and correspondingly also a substantially constant viscosity.

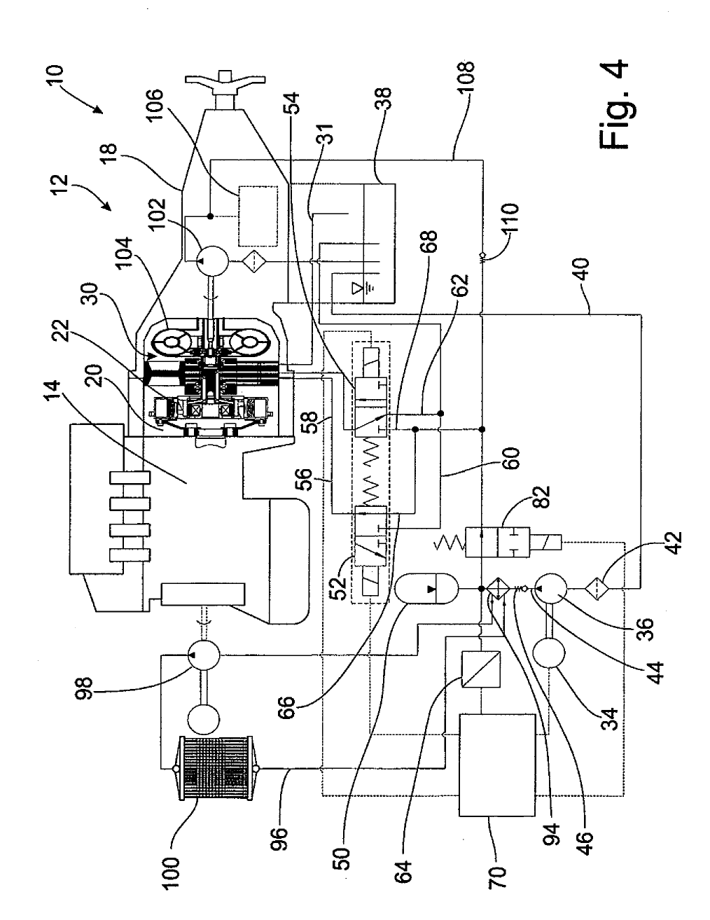

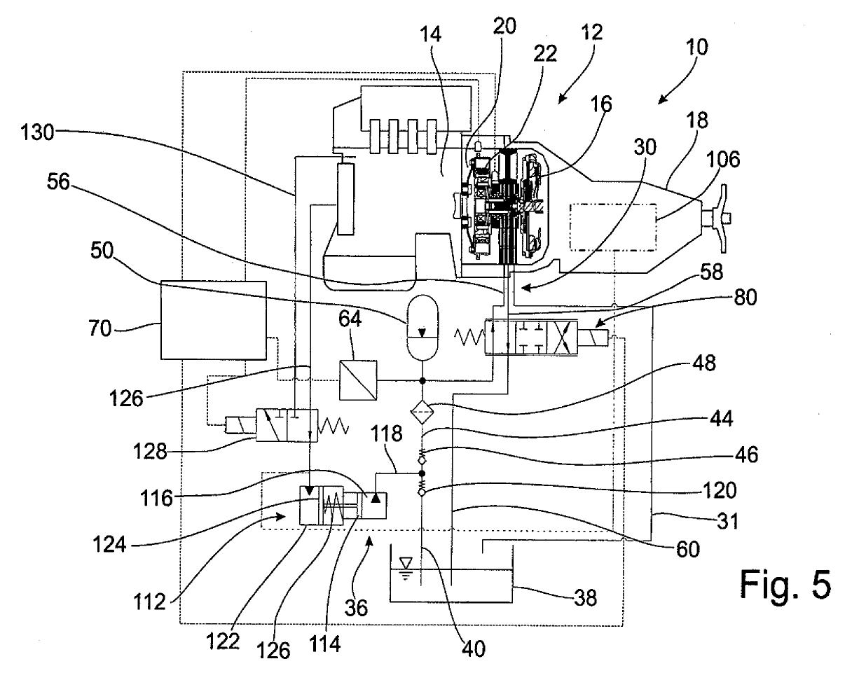

In the drivetrain 10 and torsional vibration damper system 12 shown in FIG. 4, a pressure fluid pump 36 is provided with an electric motor drive 34. As has already been mentioned, the pressure fluid pump 36 can deliver pressure fluid to the two valves 52, 54 via a pressure line 44 and pressure line segments 66, 68. In this case, a heat exchanger 94 is connected in a circuit 96 of the coolant of the drive unit 14 provided in the flow path of the pressure fluid or first damper fluid. A pump 98 which is driven by the drive unit 14 ensures that the coolant circulates through the cooling arrangement 100, the circuit 96, and therefore the heat exchanger 94. It is noted that the inclusion of a heat exchanger in the flow path of the first damper fluid can be realized in all of the constructional variants according to the invention. In heat exchanger systems of this kind, the transmission oil, which is generally heated during operation can, be used as a heat exchanger medium instead of the coolant of the drive unit so that the circuit 96 need not be connected, to the cooling arrangement 100 of the drive unit 14 but, rather, to a transmission oil cooling device. Further, the pump 98 can, also be driven by an independent drive instead of using the driving torque of the drive unit 14.

FIG. 4 also shows that a transmission oil pump 102 is provided in the transmission 18 which is constructed in this instance as an automatic transmission. This transmission oil pump 102 is driven by a hydrodynamic torque converter 104 which in turn receives a driving torque from the drive unit 14. A transmission oil circuit 106 is provided in the transmission 18. Further, the transmission oil pump 102 also supplies the required transmission oil flow in order to provide the hydrodynamic torque converter 104 with the fluid required for torque conversion.

The transmission oil pump 102 receives the first damper fluid, serving as transmission oil, from the reservoir 38 and feeds it not only to the transmission oil circuit 106 but also, via a line 108 and a check valve 110, to the pressure line segments 66, 68 or valves 52, 54. The fluid reservoir 38 can be a reservoir arranged outside of the transmission 18, but can also be arranged as a transmission oil sump in the transmission 18. When the cutoff valve 82 is switched to the blocking position, the required fluid pressure of the first damper fluid is supplied exclusively by the transmission oil pump 102. For example, when the pressure fluid pump 36 is not activated and the cutoff valve 82 is switched to the open position, the pressure accumulator 50 can also be charged by the pressure fluid pump 102. Providing the additional pressure fluid pump 36 can be advantageous when the transmission oil pump 102 is not dimensioned in such a way that it can generate the maximum fluid pressures required in the torsional vibration damper system 12. In principle, however, the system in FIG. 4 is also preferably designed such that only the transmission oil pump 102 is provided, but no additional pressure fluid pump is provided for supplying first damper fluid under pressure.

Of course, it is possible to drive the additional pressure fluid pump 36 by an electric-motor drive 34 or the drive unit 14. Both pumps 36 and 102 used for providing first damper fluid under pressure would then be driven by the drive unit 14 because, of course, the transmission oil pump 102 also uses the driving torque of the drive unit 14.

In the embodiment shown in FIG. 4, installation space can be saved when the transmission oil pump 102 has larger dimensions than required in such devices, taking into account the fact that it also supplies the volume flow for the first damper fluid, especially when the additional pressure fluid pump 36 and the drive 34 associated with it can be omitted.

FIG. 5 shows a drivetrain 10 and a torsional vibration damper system 12 in which the pressure fluid pump 36 is operated by a pump drive 112 operating with a pressure fluid. In the schematic drawing shown in FIG. 5, the pressure fluid pump 36 comprises a pump piston 114 as a pump member reciprocating in a delivery work chamber 116. The delivery work chamber 116 communicates with the suction line 40 via a line segment 118, a check valve 120 which prevents fluid from flowing back in direction of the reservoir 38 being arranged between the fluid reservoir 38 and the line segment 118. During the movement of the pump piston 114 for increasing the free volume of the delivery work chamber, the check valve 120 and the suction line 40 suck fluid out of the reservoir 38 via line segment 118. When it moves in the opposite direction for reducing the free volume of the delivery work chamber 116, fluid contained therein is expelled via the line segment 118 and guided into the pressure line 44 via the check valve 46. Accordingly, the alternating reciprocating movement of the piston pump 114 generates a correspondingly alternating suction delivery process and pressure delivery process so that first damper fluid under pressure is conducted into the pressure line 44 and, via the fluid filter 48, also into the pressure accumulator 50 or to a three-way valve 80 leading to the rotary feedthrough 30.

The pump drive 112 associated with the pressure fluid pump 36 comprises a drive work chamber 122. A drive piston 124 can move in reciprocating motion in this drive work chamber 122. The drive piston 124 is fixedly connected to the pump piston 114. The drive piston 124 and the pump piston 114 are pretensioned in a movement direction by a pretensioning spring 126, specifically in a direction in which the volume of the drive work chamber 122 is minimized and the volume of the delivery work chamber 116 is maximized.

The drive work chamber 122 can be connected to a source for the work fluid under pressure by means of a drive fluid line 126 and a switching valve 128. By switching the switching valve 128, the drive work chamber 122 can be connected to another work fluid line 130 which feeds the work fluid back in the direction of its source substantially without pressure. This means that by alternately switching the switching valve 128, the pressure of the work fluid in the drive work chamber 122 can be increased or reduced in a correspondingly alternating manner with the result that the drive piston 124 is correspondingly also loaded alternately by higher or lower pressure. This leads to a reciprocating movement of this drive piston 124 and, therefore, also of the pump piston 114.

When the piston surface areas of the two pistons 124 and 114 are substantially identical, the pressure which can be achieved in the first damper fluid with a pump drive 112 approximately corresponds to the pressure of the work fluid in the work fluid line 126. However, a ratio such that the work piston 124 provides a larger surface area than the pump piston 114, a multiplication can also be achieved such that a higher pressure can be achieved in the first damper fluid than the pressure prevailing in the area of the work fluid.

Various fluids which are present in a motor vehicle and are delivered under pressure can be used as a work fluid of the kind mentioned above. For example, it is possible to use lubricating fluid or lubricating oil of the drive unit 14 as well as the coolant or cooling water mentioned above. The hydraulic fluid of a power steering system or the coolant of an air conditioning system can also be used as work fluids of this kind, as can the fuel which is generally delivered under pressure, particularly in diesel units. The hydraulic fluid of a brake booster or ABS control device can also be used, as can the window washing water or damping fluid of an engine suspension. The transmission oil, indicated by the dashed line in FIG. 5, which is provided in a transmission oil circuit 106 and which is generally also under pressure can also be used as a work fluid of the type mentioned above.

Since the work fluid in the constructional variant shown in FIG. 5 is used only indirectly for providing first damper fluid under pressure, it is not necessary that the work fluid also has a characteristic making it suitable itself as first damper fluid. However, if this work fluid is also suitable as first damper fluid, it can be used directly as first damper fluid additionally, for example, in that a direct connection is provided between the work fluid line 126 and the pressure line 44 via the switching valve 118.

The advantage of this constructional variant shown in FIG. 5 is that there is no need for an additional pump drive to be controlled by an electric motor or by some other means. It is also possible to achieve a corresponding variation in the adjusting speed by continuously changing the valve openings, especially when a continuously switching valve is used as switching valve 128.

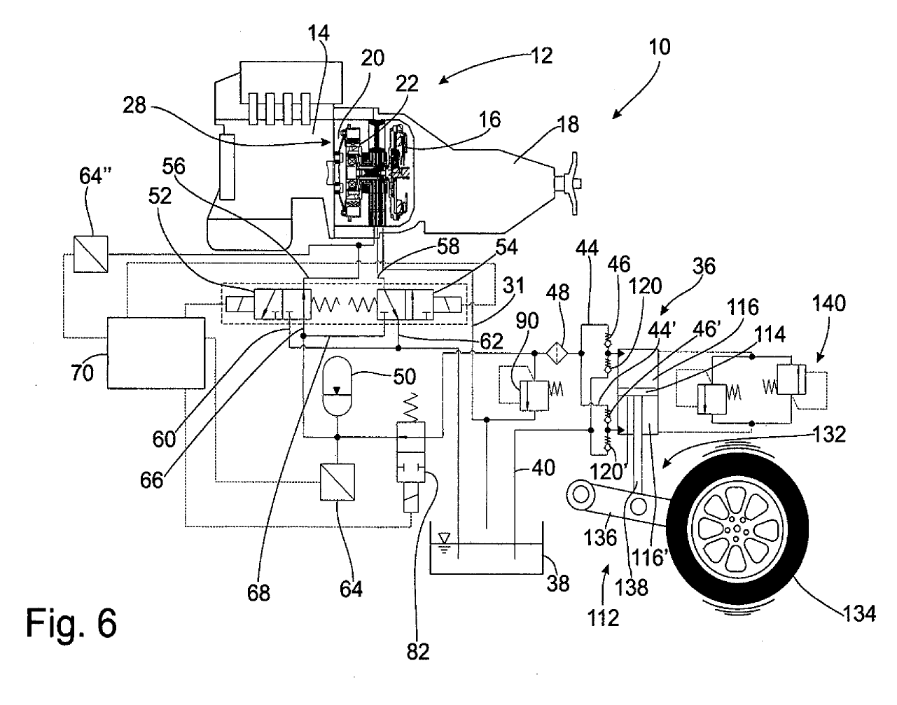

FIG. 6 shows a constructional variant in which the pressure fluid pump 36 for the first damper fluid again comprises a pump member 114, for example, in the form of a pump piston 114, which can reciprocate for generating the fluid pressure. In particular, a dual-action pump member is provided which alternately increases and reduces the volume in two delivery work chambers 116, 116′ by alternating reciprocating movement. The suction line 40 communicates with the two delivery work chambers 116 and 116′ by respective check valves 120, 120′. The pressure line 44 also communicates with the delivery work chambers 116, 116′ via two check valves 46, 46′. The check valves 120, 120′ prevent the first damper fluid from flowing back into the fluid reservoir 38 via suction line 40. Check valves 46, 46′ prevent the first damper fluid from flowing back into the delivery work chambers 116, 116′ from the pressure line 44. The first damper fluid which is expelled from the delivery work chambers 116, 116′ under pressure passes through the pressure line 44 and a fluid filter 48 to a selectively switchable cutoff valve 82 by which a connection can be produced to the pressure accumulator 50 and to the pressure line segments 66, 68 leading to the pressure regulating valves 52, 54. With excessively high pressure in the first damper fluid, a pressure limiting valve 90 can open and allow a return flow in the direction of the fluid reservoir 38.

The wheel suspension—designated generally by 132—of one or more wheels 134 of the vehicle supplies the drive 112 for the pressure fluid pump 36 and pump member 114. For example, a suspension fork 136 which is swivelably deflected at a chassis of the vehicle can be used as a driving element. The reciprocating swiveling motion of the suspension fork 136 generally occurring during operation of the vehicle can be transmitted to the pump piston 114 by a connection arrangement, shown schematically in this instance as a connecting rod 138, so that the pump piston 114 also reciprocates alternately corresponding to the more or less periodic reciprocating movement of the suspension fork 136 and, in so doing, alternately increases and decreases the volume of the two delivery work chambers 116, 116′. In this way, a movement which occurs during driving operation in any case, or the kinetic energy resulting therefrom, can be used to drive the pressure fluid pump 36 without requiring an additional drive that must be controlled.

Of course, any relative movement between two structural component parts, e.g., the chassis and a structural component of the suspension, occurring in a vehicle in driving operation can be used. Since the pressure fluid pump 36 in this constructional variant operates and increases the pressure of the first damper fluid when a relative movement occurs, it is advantageous to provide the cutoff valve 82 so that when a sufficiently high pressure is detected in the pressure line 44 or pressure accumulator 50 by the pressure sensor 64, a further increase in pressure can be prevented. When the cutoff valve 82 is switched to the blocking position, an overloading of the pressure line 44 can be prevented by the action of the pressure limiting valve 90. Of course, this protection can also be effective when the cutoff valve 82 is in its open position.

The pressure fluid pump 36 can be an independently working pump in principle, but can also be provided by a shock absorber of a chassis. A valve mechanism 140 operating in a pressure-dependent manner can be associated with the latter and, when there is a corresponding increase in pressure in the different delivery work chambers 116, 116′, can produce a connection between them and, therefore, can enable a displacement of the pump piston 114, in this case, the damper piston, which takes place with damping action. In principle, the fluid pressure occurring in the delivery work chambers 116, 116′ during the damping function can be used for generating the first damper fluid under pressure as was described above. When a certain pressure is exceeded, the valve areas of the valve mechanism 140 open and the damping function is accordingly switched on. The pressure at which the valve mechanism opens to provide a damping function is preferably selected in such a way that it lies above the pressure required for the first damper fluid in the pressure line 44. Of course, it is also possible to use other dampers in a vehicle such as, e.g., a steering damper.

FIG. 6 shows a pressure sensor 64″ that can be provided as an alternative to pressure sensor 64 in order to detect the fluid pressure in the pressure fluid lines 56, 58 directly in front of the rotary feedthrough. In this way, line losses that can occur in the area where the first damper fluid is supplied to the rotary guide can be eliminated and, therefore, the pressure can also be regulated with greater precision taking into account the driving state. Of course, this is an advantageous variant that can also be applied in the embodiment forms to be described in the following as well as in those already described above.

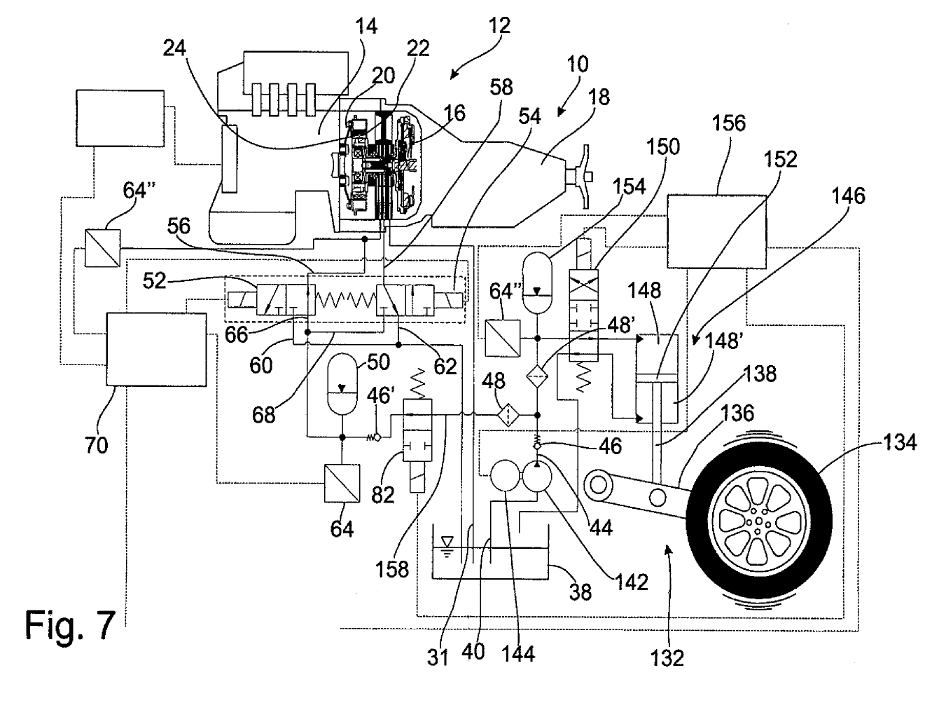

FIG. 7 shows an embodiment of a torsional vibration damper system in which a pressure fluid pump 142 which is driven, for example, by an electric motor drive 144 receives fluid from the fluid reservoir 38 via the suction line 40 and expels this fluid via the pressure line 44. This pressurized fluid serves, in principle, as a work fluid for a pressure fluid controlled/regulated chassis designated generally by 146. The fluid pressure generated by the pressure fluid pump 42 and the pressure fluid conveyed in this way can be selectively guided via a three-way valve 150 into one of the work chambers 148, 148′ in which a piston 152 is loaded by the pressure fluid and can then also transmit a force to the suspension system 132 correspondingly via a connection arrangement 138. In this way, it is possible to influence the damping characteristics and, the driving behavior of a vehicle. Further, a pressure accumulator 154 which, like the three-way valve 150, is supplied with pressure fluid via a fluid filter 48′ is associated with the pressure fluid pump 142. A pressure sensor 64″ detects the fluid pressure and delivers a corresponding signal to a control unit 156 which in particular also controls the drive 144 for the pressure fluid pump 142.

Following the check valve 46, a branch 158 leads from the pressure line 44 via a fluid filter 48 to a cutoff valve 82 and, from this cutoff valve 82 through another check valve 46′ to the pressure accumulator 50 or the pressure line segments 66, 68. When the fluid pressure for the chassis 146 which is controlled/regulated by pressure fluid is sufficiently high and when this system is not in a critical control/regulating state, the cutoff valve 82 can be switched into its open position in order to guide the pressure fluid as first damper fluid to the pressure accumulator 50 and the two valves 52, 54 so that the fluid pressure in the displacement chambers 24 can be adjusted in this way corresponding to the respective driving situation. If the suspension system is in a critical state, it is ensured by switching the cutoff valve 82 into its blocking position that the entire fluid pressure which is generated by the pressure fluid pump 142 can be used for the suspension system 146. For this reason, the cutoff valve 82 is also controlled by the control unit 156 for the chassis 146. By providing the check valve 46, it is ensured that pressure variations in the displacement chambers 24 cannot affect the fluid pressure in the area of the chassis 146.

A basic advantage of the embodiment form shown in FIG. 7 consists in that a pressure fluid pump which is already used for the chassis 146 is also used to provide the fluid pressure for the torsional vibration damper system and the displacement chambers 24 thereof. In this case, the pressure fluid of the chassis is also used as the first damper fluid.

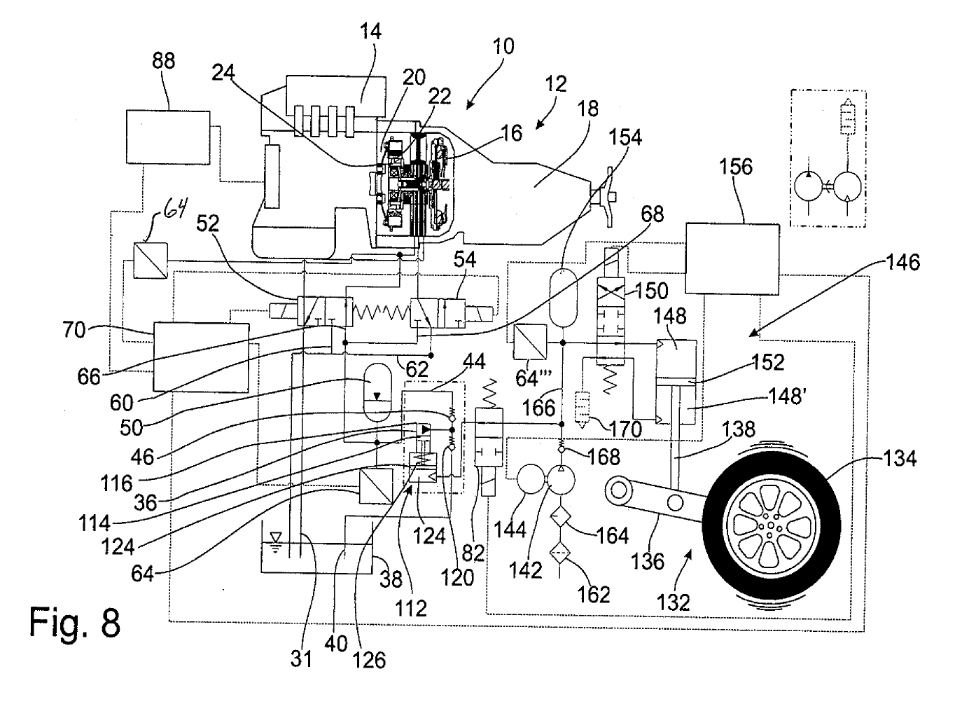

In the embodiment form shown in FIG. 8, a pressure fluid-controlled/pressure fluid-regulated chassis 146 is again provided. However, in this instance, no liquid or oil that is also suitable as first damper fluid is used as pressure fluid. Rather, air or a gaseous medium is used as the pressure fluid in the chassis 146. Accordingly, the pressure fluid pump 142 forms a compressor which is driven, e.g., by an electric motor and which receives the air via an air filter 162 and a liquid separator 164 and delivers it via a compressed air line 166 with a check valve 168. The compressed air can be introduced into the chambers 148 and 148′, respectively, by correspondingly switching the three-way valve 150 in order to influence the damping behavior of the pressure fluid-controlled/pressure fluid-regulated chassis 146 or suspension 132 in a corresponding manner. The compressed air is released outward through the valve 150 via a muffler 170.

To ensure that the conveyed or supplied compressed air is used exclusively for the chassis 146 in critical situations, a compressed air cutoff valve 82 is provided which is switched to a blocking position when such critical situations arise. If such is not the case, the compressed air cutoff valve 82 is moved to its open position so that the compressed air can then be introduced into a drive work chamber 124 of a drive 112 for the pressure fluid pump 36. The construction and functionality of the pressure fluid pump 36 corresponds to that described above with reference to FIG. 5, and reference is had to that description. Finally, in the embodiment form shown in FIG. 8, the compressed air provides the work fluid for driving the pressure fluid pump. In this case, compressed air can intermittently be introduced into the driven work chamber 124 and removed from the latter by means of the alternating opening and closing of the compressed air cutoff valve 82 so that the reciprocating operation of the pump piston 114 can be achieved again. The pressure in the pressure line can be detected by the pressure sensor 64 and fed into the control device 70 which then carries out the various control steps in interaction with the control commands of the control unit 156 and an engine control device 88, particularly in order to control the two valves 52, 54 for adjusting the pressure in the different displacement chambers 24. Of course, different rotational speed signals at the primary side 20 and secondary side 22 can also be used for this purpose.

Like the pressure accumulators described above and shown in the figures, the two pressure accumulators 50 and 154 for the first damper fluid or the compressed air in this embodiment also have the function of relieving the various pressure fluid pumps because the latter need only be operated when the pressure in the different pressure accumulators falls below a certain threshold range. Also, by providing pressure accumulators of this kind it can be ensured immediately when starting the vehicle in which different system areas are not yet active, or may be active, for supplying pressure fluid that various system areas which are to be supplied with pressure fluid, such as the displacement chambers 24, can be supplied to a sufficient degree.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-28. (canceled)

29. A torsional vibration damper system for a drivetrain of a vehicle comprising:
a primary side;
a secondary side;
a damper fluid arrangement;
a damper fluid arrangement configured to couple the primary side to the secondary side for rotation around an axis of rotation and for relative rotation with respect to one another, the damper fluid arrangement comprising:
a first damper fluid having a first compressibility that transmits a torque between the primary side and the secondary side;
a second damper fluid having second compressibility, the second damper fluid being more compressible than the first damper fluid, which is loaded when there is an increase in pressure in the first damper fluid;
at least one displacement chamber defined by the primary side and the secondary side, the at least one displacement chamber containing the first damper fluid, a volume of the at least one displacement chamber configured to be alterable by the relative rotation of the primary side with respect to the secondary side whereby the loading of the second damper fluid by the first damper fluid can be altered; and
a rotary feedthrough configured to at least one of supply and remove first damper fluid to or from the least one displacement chamber; and
a pressure fluid generation system configured to provide the first damper fluid to the damper fluid arrangement via the rotary feedthrough, the pressure fluid generation system comprising:
at least two pressure fluid pumps.

30. The torsional vibration damper system according to claim 29, further comprising at least two pressure fluid pump drives, each pressure fluid pump drive associated with a respective one of the at least two pressure fluid pumps.

31. The torsional vibration damper system according to claim 29, wherein the at least two pressure fluid pumps are driven by a shared pressure fluid pump drive.

32. The torsional vibration damper system according to claim 30, wherein at least one of the pressure fluid pump drives is an electric motor.

33. The torsional vibration damper system according to claim 29, further comprising at least two pressure accumulators each associated with a respective one of the at least two pressure fluid pumps.

34. The torsional vibration damper system according to claim 29, wherein one of the pressure fluid pumps is configured to generate a greater volume flow and the other pressure fluid pump is configured to generate a higher fluid pressure.

35. A torsional vibration damper system for a drivetrain of a vehicle comprising:
a primary side;
a secondary side;
a damper fluid arrangement; and
a damper fluid arrangement configured to couple the primary side to the secondary side for rotation around an axis of rotation and for relative rotation with respect to one another, the damper fluid arrangement comprising:
a first damper fluid having a first compressibility that transmits a torque between the primary side and the secondary side;
a second damper fluid having second compressibility, the second damper fluid being more compressible than the first damper fluid, which is loaded when there is an increase in pressure in the first damper fluid;
at least one displacement chamber defined by the primary side and the secondary side, the at least one displacement chamber containing the first damper fluid, a volume of the at least one displacement chamber configured to be alterable by the relative rotation of the primary side with respect to the secondary side whereby the loading of the second damper fluid by the first damper fluid can be altered;
a rotary feedthrough configured to at least one of supply and remove first damper fluid to or from the least one displacement chamber; and
a pressure fluid generation system configured to provide the first damper fluid to the damper fluid arrangement via the rotary feedthrough, the pressure fluid generation system comprising:
a pressure fluid pump; and
a pressure fluid pump drive associated therewith, wherein the pressure fluid pump drive comprises a vehicle drive unit.

36. The torsional vibration damper system according to claim 35, wherein the pressure fluid pump is coupled to a drive member of the vehicle drive unit in a fixed speed conversion ratio.

37. The torsional vibration damper system according to claim 35, wherein the pressure fluid pump is coupled to a drive member of the vehicle drive unit by a shiftable clutch arrangement.

38. A torsional vibration damper system for a drivetrain of a vehicle comprising:
a primary side;
a secondary side;
a damper fluid arrangement;
a damper fluid arrangement configured to couple the primary side to the secondary side for rotation around an axis of rotation and for relative rotation with respect to one another, the damper fluid arrangement comprising:
a first damper fluid having a first compressibility that transmits a torque between the primary side and the secondary side;
a second damper fluid having second compressibility, the second damper fluid being more compressible than the first damper fluid, which is loaded when there is an increase in pressure in the first damper fluid;
at least one displacement chamber defined by the primary side and the secondary side, the at least one displacement chamber containing the first damper fluid, a volume of the at least one displacement chamber configured to be alterable by the relative rotation of the primary side with respect to the secondary side whereby the loading of the second damper fluid by the first damper fluid can be altered; and
a rotary feedthrough configured to at least one of supply and remove first damper fluid to or from the least one displacement chamber; and
a pressure fluid generation system configured to provide the first damper fluid to the damper fluid arrangement via the rotary feedthrough, the pressure fluid generation system comprising:
a transmission oil pump arranged in a transmission of the vehicle.

39. The torsional vibration damper system according to claim 38, wherein the transmission oil pump is configured to pump one of the first and second damper fluids.

40. The torsional vibration damper system according to claim 38, wherein the pressure fluid generation system further comprises:
a pressure fluid pump; and
a pump drive motor configured to drive the pressure fluid pump.

41. The torsional vibration damper system according to claim 40, further comprising a valve arrangement configured to uncouple the pressure fluid pump from a pressure fluid circuit of the transmission oil pump.

42. The torsional vibration damper system according to claim 40, further comprising a pressure accumulator associated with the pressure fluid pump.

43. A torsional vibration damper system for a drivetrain of a vehicle comprising:
a primary side;
a secondary side;
a damper fluid arrangement;
a damper fluid arrangement configured to couple the primary side to the secondary side for rotation around an axis of rotation and for relative rotation with respect to one another, the damper fluid arrangement comprising:
a first damper fluid having a first compressibility that transmits a torque between the primary side and the secondary side;
a second damper fluid having second compressibility, the second damper fluid being more compressible than the first damper fluid, which is loaded when there is an increase in pressure in the first damper fluid;
at least one displacement chamber defined by the primary side and the secondary side, the at least one displacement chamber containing the first damper fluid, a volume of the at least one displacement chamber configured to be alterable by the relative rotation of the primary side with respect to the secondary side whereby the loading of the second damper fluid by the first damper fluid can be altered; and
a rotary feedthrough configured to at least one of supply and remove first damper fluid to or from the least one displacement chamber; and
a pressure fluid generation system configured to provide the first damper fluid to the damper fluid arrangement via the rotary feedthrough, the pressure fluid generation system comprising:
a pressure fluid pump; and
a pressure fluid pump drive associated with the pressure fluid pump, wherein the pressure fluid pump drive uses a third fluid as a driving medium.

44. The torsional vibration damper system according to claim 43, wherein the third fluid can be introduced intermittently into a drive work chamber to move a pump member of the pressure fluid pump alternately in reciprocating motion in a delivery work chamber of the pressure fluid pump.

45. The torsional vibration damper system according to claim 16, wherein the delivery work chamber is connected to a fluid reservoir by a suction line, the suction line including a check valve and configured to deliver the first damper fluid via a pressure line with a check valve.

46. The torsional vibration damper system according to claim 45, wherein a pressure accumulator is associated with the pressure line.

47. The torsional vibration damper system according to claim 43, wherein the third fluid is one of:
a lubricating fluid of a drive unit,
a coolant of a drive unit,
a hydraulic oil of a power steering arrangement,
a coolant of an air conditioning system,
a fuel for a drive unit,
a brake fluid of a brake system,
a window washer fluid,
a damping fluid of an engine suspension,
a compressed air of a chassis that is controlled/regulated by compressed air.

48. A torsional vibration damper system for a drivetrain of a vehicle comprising:
a primary side;
a secondary side;
a damper fluid arrangement;
a damper fluid arrangement configured to couple the primary side to the secondary side for rotation around an axis of rotation and for relative rotation with respect to one another, the damper fluid arrangement comprising:
a first damper fluid having a first compressibility that transmits a torque between the primary side and the secondary side;
a second damper fluid having second compressibility, the second damper fluid being more compressible than the first damper fluid, which is loaded when there is an increase in pressure in the first damper fluid;
at least one displacement chamber defined by the primary side and the secondary side, the at least one displacement chamber containing the first damper fluid, a volume of the at least one displacement chamber configured to be alterable by the relative rotation of the primary side with respect to the secondary side whereby the loading of the second damper fluid by the first damper fluid can be altered; and
a rotary feedthrough configured to at least one of supply and remove first damper fluid to or from the least one displacement chamber; and
a pressure fluid generation system configured to provide the first damper fluid to the damper fluid arrangement via the rotary feedthrough, the pressure fluid generation system comprising:
a pressure fluid pump comprising a delivery member reciprocating in a delivery work chamber; and
a drive associated with the delivery member, the drive comprising a drive element which is movable by the driving movement of a vehicle in driving operation and a connection arrangement between the drive element and the delivery member.

49. The torsional vibration damper system according to claim 48, wherein the drive element is at least a part of a wheel suspension.

50. The torsional vibration damper system according to claim 48, wherein the pressure fluid pump is one of:
at least a part of a shock absorber of a wheel suspension and
at least a part of a steering damper of a vehicle steering system.

51. A torsional vibration damper system for a drivetrain of a vehicle comprising:
a primary side;
a secondary side;
a damper fluid arrangement;
a damper fluid arrangement configured to couple the primary side to the secondary side for rotation around an axis of rotation and for relative rotation with respect to one another, the damper fluid arrangement comprising:
a first damper fluid having a first compressibility that transmits a torque between the primary side and the secondary side;
a second damper fluid having second compressibility, the second damper fluid being more compressible than the first damper fluid, which is loaded when there is an increase in pressure in the first damper fluid;
at least one displacement chamber defined by the primary side and the secondary side, the at least one displacement chamber containing the first damper fluid, a volume of the at least one displacement chamber configured to be alterable by the relative rotation of the primary side with respect to the secondary side whereby the loading of the second damper fluid by the first damper fluid can be altered; and
a rotary feedthrough configured to at least one of supply and remove first damper fluid to or from the least one displacement chamber; and
a pressure fluid generation system configured to provide the first damper fluid to the damper fluid arrangement via the rotary feedthrough, the pressure fluid generation system comprising:
a pressure fluid pump; and
a pressure fluid pump drive for the pressure fluid pump configured to provide pressure fluid used in a vehicle, wherein the pressure fluid also provides the first damper fluid.

52. The torsional vibration damper system according to claim 51, wherein a chassis which is controlled/regulated by the pressure fluid is provided, and the pressure fluid provided by the pressure fluid pump is supplied to the chassis for adjusting the chassis characteristics.

53. The torsional vibration damper system according to claim 52, wherein a fluid circuit of the chassis that is controlled/regulated by the pressure fluid is connected to a pressure fluid circuit of the damper fluid arrangement by a valve arrangement.

54. The torsional vibration damper system according to claim 53, wherein the fluid circuit of the damper fluid arrangement comprises a pressure accumulator.

55. The torsional vibration damper system according to claims 29, further comprising a heat exchanger arrangement configured to heat the first damper fluid.

56. The torsional vibration damper system according to claim 55, wherein the heat exchanger arrangement uses a coolant of a drive unit as a heat exchanger medium.
